(19) United States
(12) Patent Application Publication
(10) Pub. No.: US 2026/0309310 A1
(43) Pub. Date: Oct. 8, 2026

(54) LIGHTBARS WITH EMISSION COLLECTING OPTICAL MODULES

(71) Applicant: WHELEN ENGINEERING COMPANY, INC., Chester, CT (US)

(72) Inventor: Todd J. Smith, Deep River, CT (US)

(73) Assignee: WHELEN ENGINEERING COMPANY, INC., Chester, CT (US)

(21) Appl. No.: 19/652,082

(22) Filed: Apr. 20, 2026

Related U.S. Application Data
(63) Continuation-in-part of application No. 19/638,711, filed on Apr. 3, 2026.
(60) Provisional application No. 63/784,161, filed on Apr. 6, 2025.

(51) Int. Cl. F21V 13/04; F21K 9/68; F21K 9/69; F21V 5/00; F21V 5/04; F21V 7/00; F21V 17/06; F21V 19/00; F21Y 105/16; F21Y 115/10

(52) U.S. Cl. CPC F21V 13/04; F21K 9/68; F21K 9/69; F21V 5/007; F21V 5/048; F21V 7/0066; F21V 17/06; F21V 19/004; F21Y 2105/16; F21Y 2115/10

(57) ABSTRACT

A lightbar with a plurality of optical modules includes major arc arrangements wrapping around one or both ends of the lightbar and minor arc arrangements disposed along the sides of the lightbar. Modules in the major and minor arcs are oriented at constant or varying angles, including modules angled toward each other across gaps between arcs. Directional functional zoning is provided by the lightbar, with scene, warning, traffic advisor, or task functions assigned to different arcs of optical modules or regions of the lightbar, and with configurable color, intensity, timing, and synchronized flash sequences and patterns, including effect hierarchies and per-direction control.

### CROSS-REFERENCE TO RELATED APPLICATION(S)

This application is a continuation-in-part of U.S. patent application Ser. No. 19/638,711, titled “WIDE-ANGLE EMISSION COLLECTING OPTICAL SYSTEMS,” filed on Apr. 3, 2026, which is related to and claims the benefit of priority from U.S. Provisional Application No. 63/784,161, titled “WIDE-ANGLE EMISSION COLLECTING OPTICAL SYSTEMS,” filed on Apr. 6, 2025, the full disclosures of which are hereby incorporated by reference in their entirety for all purposes.

### BACKGROUND

### 1. Field of Disclosure

Embodiments of the present disclosure relate to optical systems, and particularly, embodiments relate to wide-angle optical systems designed to capture and redirect emitted light from a light source to a more desirable angle within the optical system.

### 2. Description of Related Art

Optical systems and lenses are integral components in various lighting applications, including those used in high-intensity and specialized lighting systems. These systems are designed to manipulate light to achieve specific outcomes, such as focusing, collimating, or dispersing light beams. In particular, lenses are used to direct light emitted from sources like LEDs to ensure optimal illumination patterns. The design and arrangement of these optical elements are crucial for achieving desired light distribution, intensity, and efficiency. For instance, in high-performance lighting systems, precise control over the light beam is essential to ensure visibility and effectiveness in various conditions.

In optical systems that incorporate LED light sources, it is common to encounter issues related to the mismatch between the lens acceptance angle and the light source emission pattern. Traditional LED light sources emit light in a hemispherical pattern, which often results in significant portion of the emitted light being missed by the lens, leading to inefficiencies in light collection and direction.

Various approaches have been attempted to address this issue, including the use of collimating or concentrating lenses. These lenses are designed to collect and direct light emitted from the source, but they often encounter limitations when the emission pattern of the source exceeds the acceptance angle of the lens. This mismatch results in a loss of lumens and a less efficient optical arrangement. Previous technology has focused on optimizing the lens design and geometry to better match the emission pattern of the light source. For example, increasing the focal length of the lens can produce a narrower beam width and higher peak intensity, but this may also reduce the acceptance angle, which may lead to a direct loss in lumens. Additionally, increasing the focal length may necessitate the optical system itself to increase in size, however, in many situations, it is beneficial for the optical system to be more compact.

### SUMMARY

Applicants recognized the problems noted above herein and conceived and developed embodiments of optical systems, according to the present disclosure, for capturing wide-angle emitted light to increase efficiency of optical systems.

In an embodiment, an optical system includes one or more light sources configured to produce emitted light, a lens, a cradle supporting the lens, and a wide-angle emission collecting optic positioned, at least in part, within the cradle. The wide-angle emission collecting optic has a substantially concave shape. A first portion of the emitted light from the one or more light sources is reflected off of the wide-angle emission collecting optic to produce reflected light, and the reflected light passes through and out of the lens.

In another embodiment, an optical assembly includes two or more optical systems, a plate, and one or more snapping arms, where the one or more snapping arms secure the plate to the two or more optical systems. Each optical system includes one or more light sources configured to produce emitted light, a lens, and a wide-angle emission collecting optic positioned within the optical system. A portion of the emitted light from the one or more light sources is reflected off of the wide-angle emission collecting optic to produce reflected light, and the reflected light passes through and out of the lens. The two or more optical systems are arranged in one or more columns and one or more rows on the plate.

In yet another embodiment, an optical lens includes a center line, a focal point, and a refracting lens section about the center line. The refracting lens section includes a refracting entrance surface and a refracting exit surface.

### BRIEF DESCRIPTION OF DRAWINGS

The present technology will be better understood on reading the following detailed description of non-limiting embodiments thereof, and on examining the accompanying drawings, in which:

FIG. 1 is a schematic diagram of a lens system, in accordance with embodiments of the present disclosure;

FIG. 2 is a schematic diagram of an optical system, in accordance with embodiments of the present disclosure;

FIG. 3 is a schematic diagram of a lens system, in accordance with embodiments of the present disclosure;

FIG. 4 is a schematic diagram of an optical system, in accordance with embodiments of the present disclosure;

FIG. 5 is a schematic diagram of a wide-angle emission collecting optical system, in accordance with embodiments of the present disclosure;

FIG. 6A is a cross-sectional view of a wide-angle emission collecting optical system, in accordance with embodiments of the present disclosure;

FIG. 6B is a isometric cross-sectional view of the wide-angle emission collecting optical system, in accordance with embodiments of the present disclosure;

FIG. 7A is a isometric view of an assembly of multiple of the wide-angle emission collecting optical systems, in accordance with embodiments of the present disclosure;

FIG. 7B is a top view of an assembly of multiple of the wide-angle emission collecting optical systems, in accordance with embodiments of the present disclosure;

FIG. 8 is a schematic diagram of an optical lens, in accordance with embodiments of the present disclosure;

FIG. 9A is a top view of a hexagonal fixture with optical assemblies disposed around the perimeter, in accordance with embodiments of the present disclosure;

FIG. 9B is a top view of a lightbar with optical assemblies disposed at each end of the lightbar and other lights disposed on the perimeter, in accordance with embodiments of the present disclosure;

FIG. 10A is a perspective view of a lightbar with optical assemblies in a major arc at each end of the lightbar and optical assemblies in a minor arc on each side of the lightbar, in accordance with embodiments of the present disclosure;

FIG. 10B is a perspective view of a lightbar with a protective lens, in accordance with embodiments of the present disclosure;

FIG. 11 is a perspective view of a shortened lightbar partially enclosed by a protective lens, in accordance with embodiments of the present disclosure; and

FIGS. 12A-12C are schematic top views of example lighting configurations, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/−10 percent. Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

Embodiments of the present disclosure relate to optical systems designed to address inefficiencies associated with mismatched lens acceptance angles and light source emission patterns. Embodiments of the present disclosure are particularly beneficial when precise control of light direction and intensity is critical, such as in advanced lighting systems, for example, in emergency vehicles. Depending on the application, it is often beneficial to increase the peak intensity of an optical system, which may be achieved by increasing focal length. However, an increase in focal length past the focal point of a lens can cause larger portions of rays of light to be emitted from a light source at an angle greater than the acceptance angle of the lens. Such rays will miss the lens and fail to be projected out of the optical system, which is an inefficiency of the optical system.

Various embodiments of the present disclosure include a wide-angle emission collecting optic, which functions to enhance the efficiency of an optical system. This optic is strategically positioned to reflect rays emitted at angles greater than the lens acceptance angle back towards the collimating lens. By converging these rays before they enter the lens, the system effectively captures and redirects light that would be lost in the optical system, reduces the halo effect, and increases the overall intensity and uniformity of the emitted beam. This embodiment is particularly advantageous in scenarios where peak intensity and aperture size are critical, offering a solution to the negative effects of mismatched acceptance angles and emission patterns.

The embodiments discussed herein may also encompass variations in the focal length and acceptance angle of the lens, allowing for customization based on specific application requirements. For instance, increasing the focal length results in a narrower beam width and higher peak intensity, while adjusting the acceptance angle can optimize the aperture size and light collection efficiency. These modifications provide flexibility in designing optical systems tailored to diverse needs, from high-intensity spotlights to wide-angle illumination devices.

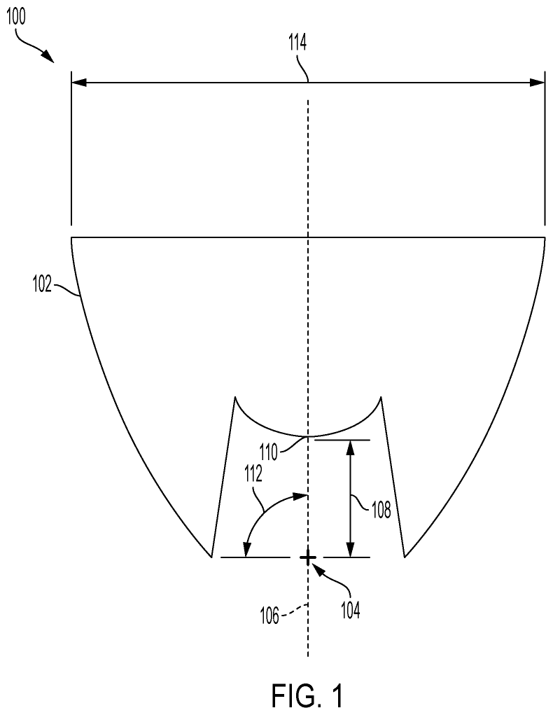

FIG. 1 is a schematic diagram of a lens system 100. The lens system 100 includes a collimating or concentrating lens 102. The lens 102 has a focal point 104 coincident to a center line 106. The lens system 100 may be substantially symmetrical along the center line 106. A focal length 108 may be collinear to the center line 106 from the focal point 104 to a vertex 110 of the lens 102. The lens 102 also may include an acceptance angle 112, which is the maximum angle at which light can enter the lens 102 and still be effectively focused or transmitted through the lens system 100. The lens 102 may further include an aperture 114, which is the area of the lens 102 through which light can pass. As can be seen in the figure, the lens 102 has a substantially flat upper portion, with curved portions that extend downwards on each side of the focal point, as well as a convex portion at the vertex 110.

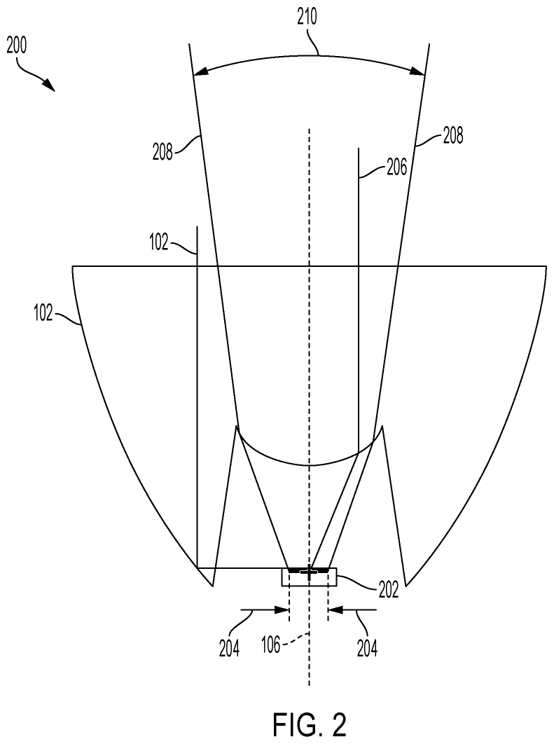

FIG. 2 is a schematic diagram of an optical system 200 that is similar to the optical system 100 of FIG. 1, but with a light source 202 added to the optical system 200. The light source 202 (e.g., “emitter 202,” “LED light source 202,” or “LED 202”) may be a light-emitting diode (LED). As can be seen from FIG. 2, the LED light source 202 of the optical system 200 is substantially centered on the focal point 104 of the lens 102. In the embodiment illustrated, the lens 102 has an acceptance angle 112 which may be the same or similar to emission pattern of the light source 202. In such case, the lens 102 will collect substantially all or nearly all of the energy emitted by the light source 202. The LED light source 202 may also have an emitter size or area 204.

In the optical system 200 of FIG. 2, rays of light emitted from the light source 202 at the focal point 104 that pass through the lens 102 are generally collimated. An example collimated ray 206 is shown in FIG. 2. After the collimated ray 206 generated by the emitter 202 at the focal point 104 passes into the lens 102, it is collimated and passes through the lens 102 substantially parallel to the center line 106. On the other hand, rays of light emitted from the light source 202 outside of the focal point 104 that pass through the lens 102 are generally not collimated. Two example uncollimated rays 208 are shown in FIG. 2. After the uncollimated rays 208 generated by the emitter 202 outside the focal point 104 pass into the lens 102, they travel through the lens 102 and out of the lens 102 at an angle substantially oblique to the center line 106 and at an angle substantially oblique to the collimated rays 206. Uncollimated rays 208 may also generally diverge from each other. In the illustrated embodiment of FIG. 2, the uncollimated rays 208 that pass through the lens 102 define a beam width angle 210 of the optical system 200.

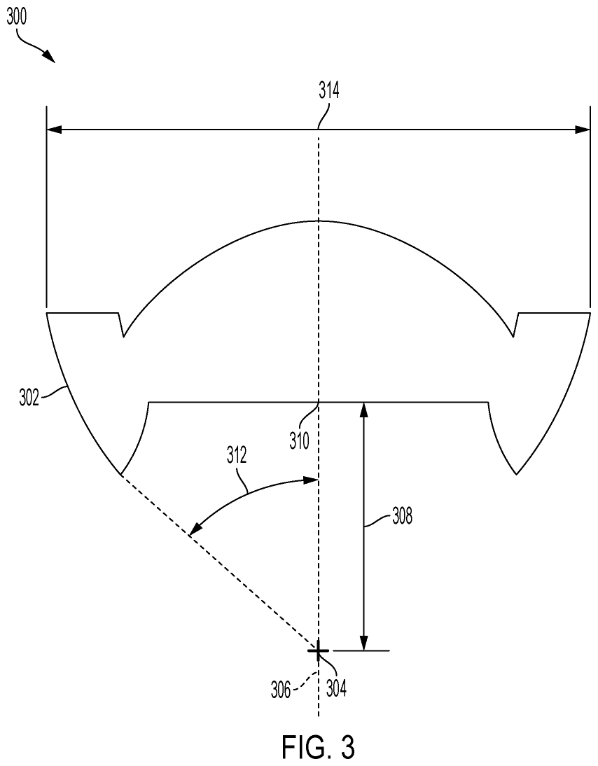

FIG. 3 is a schematic diagram of a lens system 300. The lens system 300 includes a collimated or concentrating lens 302, which has a focal point 304 coincident to a center line 306. The lens 302 further includes a focal length 308 collinear to the center line 306, from the focal point 304 to a vertex 310 of the lens 302. The lens 302 also has an acceptance angle 312 and an aperture 314. The lens 302 has a different shape, among other features, than the lens 102 of FIGS. 1 and 2. As can be seen in FIG. 3, the lens 302 has a curved upper portion, rather than the flat portion of the lens 102 of FIGS. 1 and 2. Additionally, the lens 302 has a substantially flat lower portion that is substantially perpendicular to the center line 306. The lens 302 also includes lip or wing portions on the outside of the lens 302 on each side of the vertex 310.

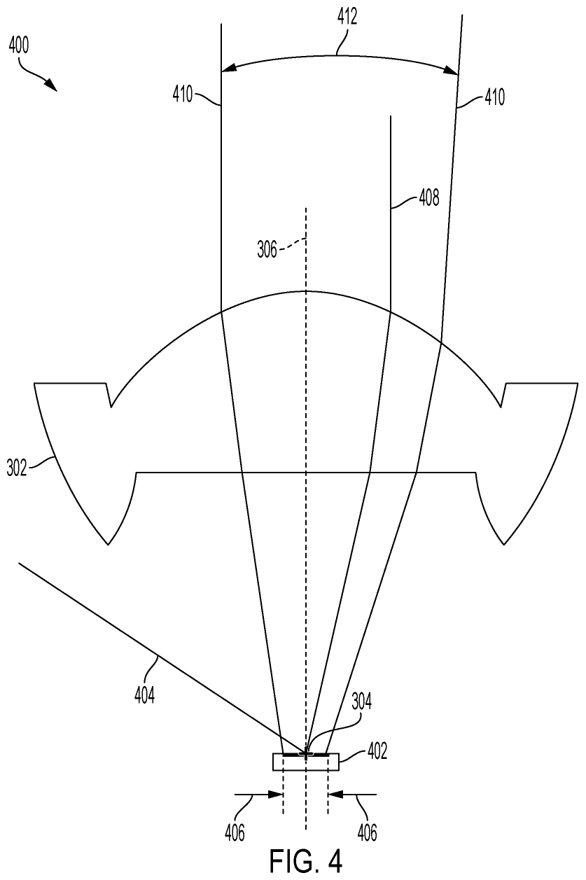

FIG. 4 is a schematic diagram of an optical system 400 that includes the same collimating or concentrating lens 302 as FIG. 3, however, the optical system 400 further includes a light source 402, which may be an LED or another suitable type of light source. The light source (e.g., “emitter 402,” “LED light source 402,” or “LED 402”) may be substantially centered on the focal point 304 of the lens 302, however, the light source may also not be centered on the focal point 304 of the lens 302. It should be appreciated that although a single LED light source 402 is illustrated in FIG. 2, there may be any reasonable number of light sources 402 included in the optical system 400. In some embodiments of the present disclosure, there are three LEDs 402 included in the optical system 400, and each LED 402 may emit light of a different color. In embodiments with multiple light sources, a first light source may be substantially centered on the focal point 304 of the lens 302 and a second light source may be positioned at a location that in the optical system 400 that is off of the focal point 304 of the lens 302.

The lens 302 of the optical system 400 may have an acceptance angle 312 that is less than the emission pattern of the LED 402, which may result in the lens 302 collecting a fraction of the energy emitted by the LED 402. As such, some wide-angle rays 404 of light generated from the emitter 402 that are greater than the acceptance angle 312 may miss the lens 302 and therefore may result in a less efficient optical arrangement, as the wide-angle rays 404 do not pass through the lens 302 and are not emitted outward from the optical system 400. The emitter 402 also has an emitter size or area 406.

Rays of light emitted from the light source 402 at the focal point 304 that pass through the lens 302 are generally collimated. An example collimated ray 408 is shown in FIG. 4. After the collimated ray 408 generated by the emitter 402 at the focal point 304 passes into the lens 302, it is collimated and passes through the lens 302 substantially parallel to the center line 306. On the other hand, rays of light emitted from the light source 402 outside of the focal point 304 that pass through the lens 302 are generally not collimated. Two example uncollimated rays 410 are shown in FIG. 4. After the uncollimated rays 410 generated by the emitter 402 outside the focal point 304 pass into the lens 302, the uncollimated rays 410 may travel through the lens 302 and out of the lens 302 at an angle substantially oblique to the center line 306 and at an angle substantially oblique to the collimated rays 408. Uncollimated rays 410 may also generally diverge from each other. In the illustrated embodiment of FIG. 4, the uncollimated rays 410 that pass through the lens 302 define a beam width angle 412 of the optical system 400.

As illustrated, the focal length 308 of the lens 302 of the optical system 400 of FIG. 4 is greater than the focal length 108 of the lens 102 of the optical system 200 of FIG. 2. Assuming optical system 200 and optical system 400 have the same light source 202, 402, same emission pattern, and equal lumens, the increased focal length 308 of optical system 400 of FIG. 4 may produce a narrower beam width angle 412 than the beam width angle 210 of optical system 200 of FIG. 2. A narrower beam width angle 412 may produce a higher peak intensity of the light from the optical system 400. However, due to the greater focal length 308, the acceptance angle 312 of the optical system 400 of FIG. 4 may be less than the acceptance angle 112 of the optical system 200 of FIG. 2. Increasing the focal length 308 may also increase the aperture 314 if the acceptance angle 312 of the optical system 400 of FIG. 4 were to be the same as the acceptance angle 112 of the optical system 200 of FIG. 2. Reducing the acceptance angle 312 as shown in FIG. 4 and described above, can be beneficial when the size of the aperture 314 and peak intensity are the most critical outcomes, however, the downside to this may be a direct loss in lumens due to a mismatch of the acceptance angle 312 and the emission pattern of the LED 402.

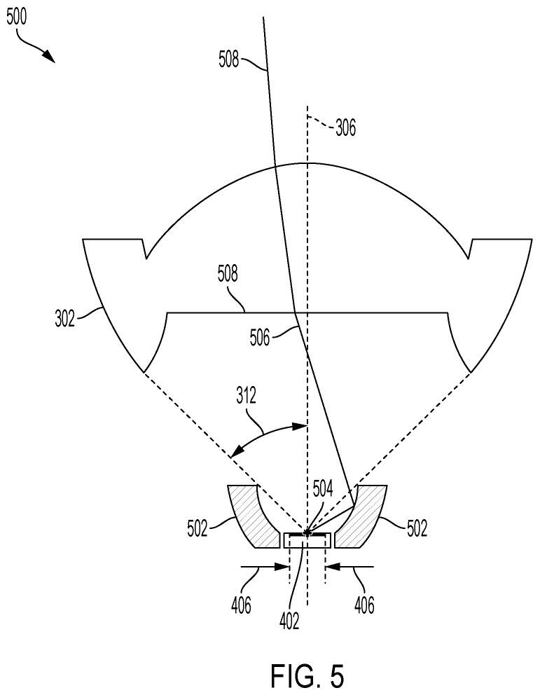

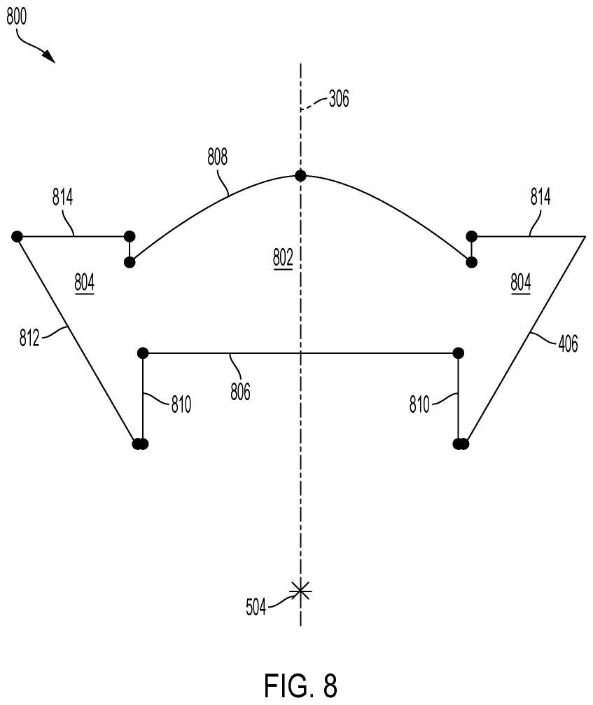

FIG. 5 is a schematic diagram of a wide-angle emission collecting optical system 500 that includes a similar collimated or concentrating lens 302 as in FIGS. 3 and 4, but additionally includes at least one wide-angle emission collecting optic 502 adjacent to the LED light source 402. The particular sections and surfaces of the wide-angle emission collecting optical system 500 are discussed in more detail in FIG. 8. As with FIG. 3, the lens 302 has a center line 306 and an acceptance angle 312. Additionally, as with FIG. 4, the LED 402 has an emitter size or area 406. It should be appreciated that in the two-dimensional schematic diagram of FIG. 5, there exists two wide-angle emission collecting optics 502, however, there may be any reasonable amount of wide-angle emission collecting optics 502. Furthermore, the wide-angle emission collecting optic 502 may be a single optic 502 that substantially surrounds the light source 402. Moreover, the wide-angle emission collecting optic 502 may function as a reflector, and the wide-angle emission collecting optic 502 may also function as a Total Internal Reflection (TIR) lens.

The wide-angle emission collecting optic 502 may have a focal point 504 that is substantially coincident with the focal point 304 of the lens 302. Also, the wide-angle emission collecting optic 502 may reflect nearly all or all rays (e.g., “reflected rays 504”) of light emitted at an angle greater than the acceptance angle 312 of the lens 302. As can be seen in FIG. 5, one of the wide-angle emission collecting optic 502 may reflect the reflected ray 506 in the direction of the lens 302. It should be appreciated that although there is only one example of a reflected ray 506 illustrated in FIG. 5, there can be any number of reflected rays 504 emitted from the light source 402 that are reflected off of the wide-angle emission collecting optics 502 toward the lens 302, and such reflections may occur at numerous different angles towards the lens 302, causing the reflected rays 504 to enter the lens 302 at different locations along the base (e.g., bottom surface) of the lens 302.

Furthermore, the reflected ray 506 may converge toward the center line 306 before entering the base of the lens 302. The angle at which the reflected ray 506 enters the base of the lens 302 may define the beam shape or width of the optical system 500 overall. The reflected ray 506 may pass through lens 302 and leave the lens 302 as an uncollimated reflected ray 508. The uncollimated reflected rays 508 may travel out of the lens 302 at an angle substantially oblique to the center line 306 and at an angle substantially oblique to the collimated rays 408 and the uncollimated rays 410 that pass through the lens 302 directly from being emitted from the light source 402. Uncollimated reflected rays 508 may also generally diverge from each other.

In various embodiments, the bottom portion of the wide-angle emission collecting optic 502 (i.e., the portion of the wide-angle emission collecting optic 502 closest to the light source 402) wraps substantially the entire way around the light source 402 as close as possible to the light source 402, as if it were an extension of the light source 402 itself. In such embodiments, positioning the wide-angle emission collecting optic 502 as close as possible to the light source 502 may function to reduce any potential halo effect around the beam produced from the optical system 500 by the collimated rays 408. In some embodiments, the upper portion of the wide-angle emission collecting optic 502 (i.e., the portion of the wide-angle emission collecting optic 502 furthest from the light source 402) is substantially coincident with the acceptance angle 312 of the lens 302. In contrast to FIG. 4, the wide-angle emission collecting optic 502 of FIG. 5 collects and redirects nearly all of the wide-angle rays 404 that would miss the lens 302 and result in a less efficient optical arrangement.

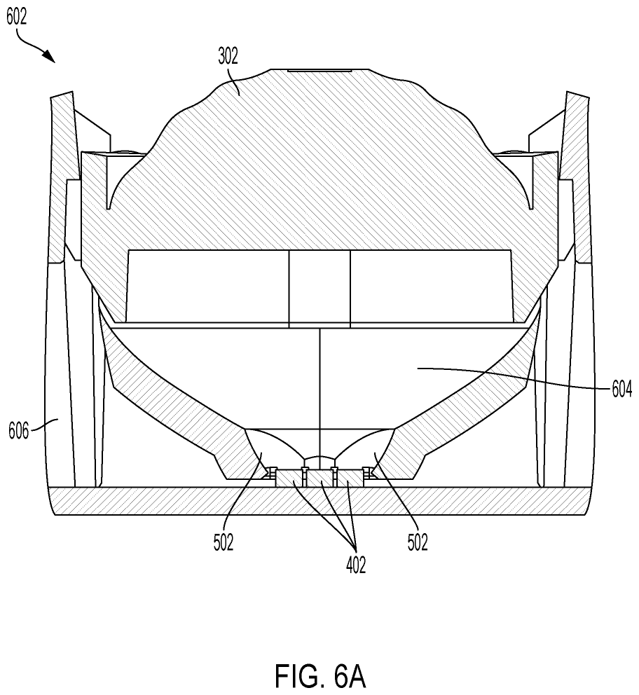

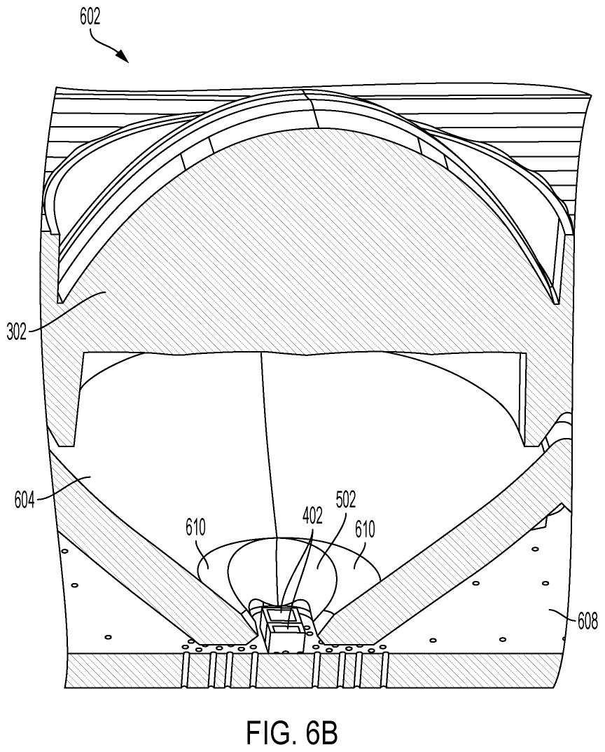

FIG. 6A is a cross-sectional view of a wide-angle emission collecting optical system 602 (e.g., “optical system 602”) that may include two wide-angle emission collecting optics 502, a similar lens 302 as depicted in FIGS. 3, 4, and 5, and three LED light sources 402. The optical system 602 further includes a cradle 604. In various embodiments, the cradle 604 may not have any optical or reflective properties and may instead be a piece designed to hold the lens 302 and provide a structure for the optical system 602. In other embodiments, the cradle 604 may have reflective properties that further directs light emitted from the light sources 402 out of the optical system 602. The optical system 602 may also include one or more internal structural pieces 606 outside of the optic itself. The internal structural pieces 606 may be structural components within the wide-angle emission collecting optical system 602 to provide stability to the optical system 602. The internal structural pieces 606 may also function to connect the optical system 602 to other optical systems 602, and also may function to be compatible with a larger arrangement of optics.

In some embodiments, the collecting optic 502 may be a reflector. The collecting optic 502 may be integrated into the cradle 604 that holds the concentrating lens 302, or may be a separate component connected to the cradle 604. As an example, the collecting optic 502 may be a metallicized opening at the bottom of the cradle 604 that reflects light from the LED light sources 402.

FIG. 6B is a perspective cross-sectional view of the wide-angle emission collecting optical system 602 as depicted in FIG. 6A. As described above, the wide-angle emission collecting optical system 602 may include the lens 302, the LED light sources 402, the wide-angle emission collecting optic 502, and the cradle 604. It is important to note that, since FIG. 6B is a cross-sectional view, only one wide-angle emission collecting optic 502 is shown, and one and a half of the three LED light sources 402 of FIG. 6A are shown. The wide-angle emission collecting optical system 602 may further include a printed circuit board (PCB) 608 that may mechanically support and electrically connect electronic components of an optical system. In another embodiment, the wide-angle emission collecting optical system 602 is positioned on a plate, rather than the PCB, that provides mechanical and structural support and no electrical connectivity.

FIG. 6B further illustrates one or more transition portions 610 that may be positioned adjacent to the wide-angle emission collecting optics 502 and the cradle 604. The transition portions 610 may reflect light emitted by the LED light sources 402 or they may be non-reflective. In various embodiments, the wide-angle emission collecting optic 502, the cradle 604, and the one or more transition portions 610 may be a single mold, provided as a single molded structure. The one or more transition portions 610 may have an inconsistent shape as a result of the molding process. In embodiments, the mold is a reflective material with a reflective surface (e.g., metals, mirrored surfaces, glossy surfaces, or specialized coatings). In such embodiments, the wide-angle emission collecting optic 502, the cradle 604, and the one or more transition portions 610 may all be made of a continuous reflective material from the same molded piece.

In some embodiments, the wide-angle emission collecting optical systems 602 may be a separate and distinct piece than the cradle 604 and/or the transition portions 610. For example, the wide-angle emission collecting optical system 602 may be made of a reflective material, whereas the cradle 604 and/or the transition portions 610 are made of an matte, dull, absorptive, or otherwise non-reflective material.

In various embodiments, the wide-angle emission collecting optical system 602 may have a substantially concave shape. In some embodiments, the wide-angle emission collecting optical system 602 may have a substantially conical shape or a shape that substantially resembles a portion of a cone (e.g., a half of a cone). In some embodiments, the wide-angle emission collecting optical system 602 may have a shape that substantially resembles a truncated cone or a shape that substantially resembles a portion of a truncated cone (e.g., a half of a truncated cone). In some embodiments, the wide-angle emission collecting optical system 602 may have a shape that substantially cylindrical shape or a shape that substantially resembles a portion of a cylinder (e.g., a half of a cylinder). In other embodiments, the wide-angle emission collecting optical system 602 may have a shape that substantially resembles a portion of the interior of a sphere (e.g., a hemispherical shape or quarter of a sphere).

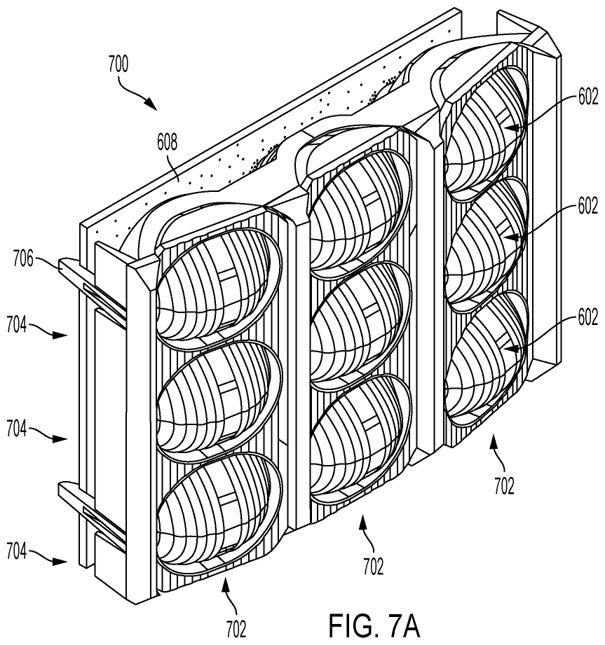

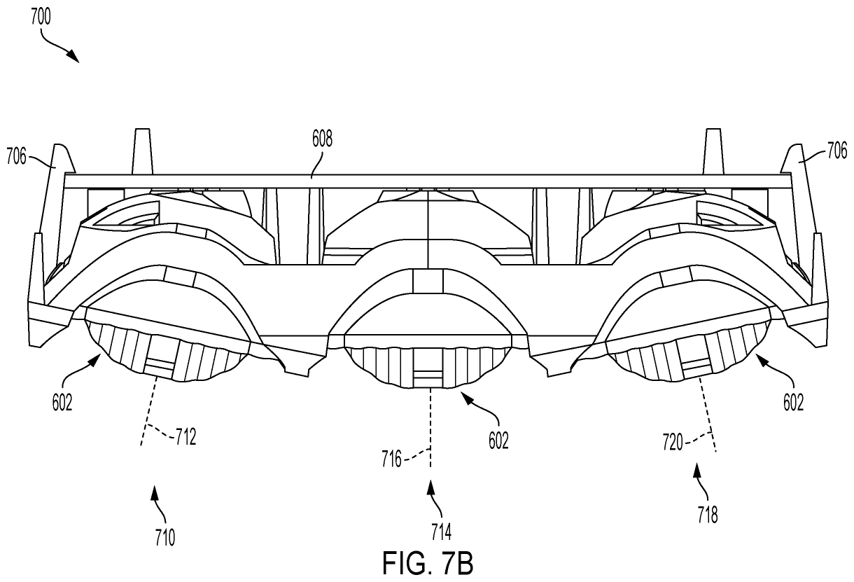

FIG. 7A is a isometric view of an optics assembly 700 (e.g., “assembly 700”) of multiple of the wide-angle emission collecting optical systems 602 arranged on the PCB 608. It should be appreciated that although nine wide-angle emission collecting optical systems 602 are positioned on the PCB 608 depicted in the assembly 700 of FIG. 7, there may be any reasonable number of wide-angle emission collecting optical systems 602 included in the assembly 700. Furthermore, the wide-angle emission collecting optical systems 602 are positioned in the assembly 700 in three columns 702 and three rows 704 (e.g., a 3×3 arrangement), however, there may be any reasonable amount of columns 702 and rows 704 of wide-angle emission collecting optical systems 602. Moreover, every column 702 of wide-angle emission collecting optical systems 602 may be oriented to point in the substantially same direction, or each column 702 of wide-angle emission collecting optical systems 602 may be oriented to emit light in different directions relative to other columns 702.

In an embodiment, each column 702 of wide-angle emission collecting optical systems 602 may be oriented at an angle that is, for example, 60 degrees offset from the angle of the column 702 on either side. For instance, in such embodiment, there may be a first column 702 oriented at 0 degrees, a second column 702 oriented at 60 degrees, a third column 702 oriented at 120 degrees, a fourth column 702 oriented at 180 degrees, a fifth column 702 oriented at 240 degrees, and a sixth column 702 oriented at 300 degrees. In such an arrangement, for example, the fourth column 702 is at an angle of 60 degrees from the third column 702 and at an angle of 60 degrees from the fifth column 702. Also in such arrangement, there are 6 total columns 702 of wide-angle emission collecting optical systems 602 in a single assembly 700 that extend substantially in a full circle, a 360-degree arrangement. In such 360-degree arrangement, the PCB 608 may be a hexagonal shape positioned substantially in the middle of the assembly 700, with the wide-angle emission collecting optical systems 602 positioned around the hexagonal PCB. However, it should be appreciated that the columns 702 of wide-angle emission collecting optical systems 602 could be at progressive angles of 1, 2, 3, 5, 10, 15, 20, 30, 45, 60, 90, 120, 180, or any reasonable angle.

The assembly 700 of multiple of the wide-angle emission collecting optical systems 602 may further include one or more cantilevers or snapping arms 706 that function to secure the wide-angle emission collecting optical systems 602 to the PCB 608. The one or more snapping arms 706 may retain tension on the PCB 608 such that the wide-angle emission collecting optical systems 602 remain in place. The one or more snapping arms 706 also allow for quick service and replacement of the optics assembly 700, for example, if the assembly 700 is provided on a larger structure, such as a lightbar or other fixture.

In various embodiments, within a single optics assembly 700, the wide-angle emission collecting optical systems 602 may be diversified to produce complementary beam coverage. Within a single 3×3 optics assembly 700, the nine optical systems 602 may be homogeneous or heterogeneous, including different beam profiles such as spot, flood, elliptical, asymmetric, total internal reflection (TIR), or compound reflector geometries. Individual optics may be configured for distinct wavelengths or colors (e.g., red, blue, amber, white, ultraviolet, etc.), and may include polarization or diffuser structures to tailor output. In an example, individual rows or columns within a single optics assembly 700 are pre-assigned to specific colors—such as a top row of red, a middle row of white, and a bottom row of blue—to achieve vertical stratification of color effects. The PCB may incorporate independent current-control channels per light source and calibration for color and intensity, enabling precise per-optic control and color blending within a single optics assembly 700. The PCB may receive control signals from a control unit internal to the lightbar, or from a control unit separate from the lightbar and in wired or wireless communication with the PCB.

In some embodiments, the optics assembly 700 may have a layout of wide-angle emission collecting optical systems 602 in arrangements other than a 3×3 arrangement (the 3×3 arrangement of optics is shown in the embodiment of FIG. 7A). For example, the wide-angle emission collecting optical systems 602 may be provided in arrangements such as 2×2 or 1×3. Such arrangements may be implemented, for example, where needed to fill geometric gaps in an oval, hexagon, or octagon fixture, or to accommodate constrained mounting spaces.

FIG. 7B is a top view of the optics assembly 700 of multiple of the wide-angle emission collecting optical systems 602 arranged on the PCB 608. As can be seen, two cantilevers or snapping arms 706 can be seen on both sides of the PCB 608 that secure the wide-angle emission collecting optical systems 602 to the PCB 608. Additionally, a first column 710 of one or more wide-angle emission collecting optical systems 602 is oriented at a first direction 712, a second column 714 of one or more wide-angle emission collecting optical systems 602 is oriented at a second direction 716, and a third column 718 of one or more wide-angle emission collecting optical systems 602 is oriented at a third direction 720. Similar to what is described above with respect to FIG. 7A, the first direction 712 may be at any reasonable angle relative to the second direction 716 and the second direction 716 may be at any reasonable angle relative to the third direction 720. Also, the angle between the first direction 712 and the second direction 716 may be substantially the same angle as the angle between the second direction 716 and the third direction 720. Furthermore, depending on the particular embodiment, the second direction 716 may be perpendicular to the PCB 608, whereas the first direction 712 and third direction 720 may be at an angle oblique to the PCB 608.

FIG. 8 is a schematic diagram of an optical lens 800, according to various embodiments of the present disclosure. As with other lenses discussed herein, the optical lens 800 may include the center line 306 and the focal point 504. Further, the optical lens 800 may include a refracting lens section 802 and a TIR lens section 804. The TIR lens section 804 may substantially surround the refracting lens section 802, with the refracting lens section 802 in the middle of the optical lens 800 and having the center line 306 passing through the refracting lens section 802. It should be appreciated that FIG. 8 is a two-dimensional representation of the optical lens 800, therefore the TIR lens section 804 may extend substantially around the center line 306 when viewing the optical lens 800 in three dimensions. Rays of light may enter the optical lens 800 at an entrance surface 806 of the refracting lens section 802, then the rays of light may exit the refracting lens section 802 through an exit surface 808 of the refracting lens section 802. The entrance surface 806 of the refracting lens section 802 may be substantially flat and comprise a plane substantially perpendicular to the center line 306, or the entrance surface 806 may have a curve or an angled surface relative to the center line 306. The exit surface 808 of the refracting lens section 802 may have a substantially domed shaped, as can be seen in FIGS. 6B, 7A, and 7B.

Additionally regarding FIG. 8, other rays of light may enter the optical lens 800 at a TIR entrance surface 810 of the TIR lens section 804. These rays of light that enter the TIR lens section 804 through the TIR entrance surface 810 may also reach a TIR surface 812 of the TIR lens section 804. The TIR entrance surface 810 of the TIR lens section 804 may be substantially flat and comprise a plane substantially parallel to the center line 306, or the TIR entrance surface 810 may have a curve or an angled surface relative to the center line 306. Further, the rays of light in the TIR lens section 804 may exit the optical lens 800 through a TIR exit surface 814 of the TIR lens section 804. The TIR exit surface 814 of the TIR lens section 804 may be substantially flat and comprise a plane substantially perpendicular to the center line 306, or the TIR exit surface 814 may have a curve or an angled surface relative to the center line 306.

In various embodiments, the optical assembly (such as the optical assembly 700 depicted in FIG. 7A) may function as a modular building block that can be replicated, tiled, combined, or otherwise arranged and provided on larger structures, including but not limited to lightbars and multi-faceted fixtures. Moreover, multiple optical assemblies may be connected together, including at different angles with respect to each other. For example, multiple sections may be connected linearly or at angles such that the assemblies form a curve. In this manner, multiple assemblies could be connected together to form a lightbar with two ends formed by assemblies connected at angles to one another forming curved ends, and multiple assemblies connected together linearly along the sides of the lightbar. Two or more assemblies may be connected to a single bracket mount, or each assembly may be connected to its own bracket. Brackets to which one or more assemblies are attached may be connected together, or may be connected to a common mounting structure.

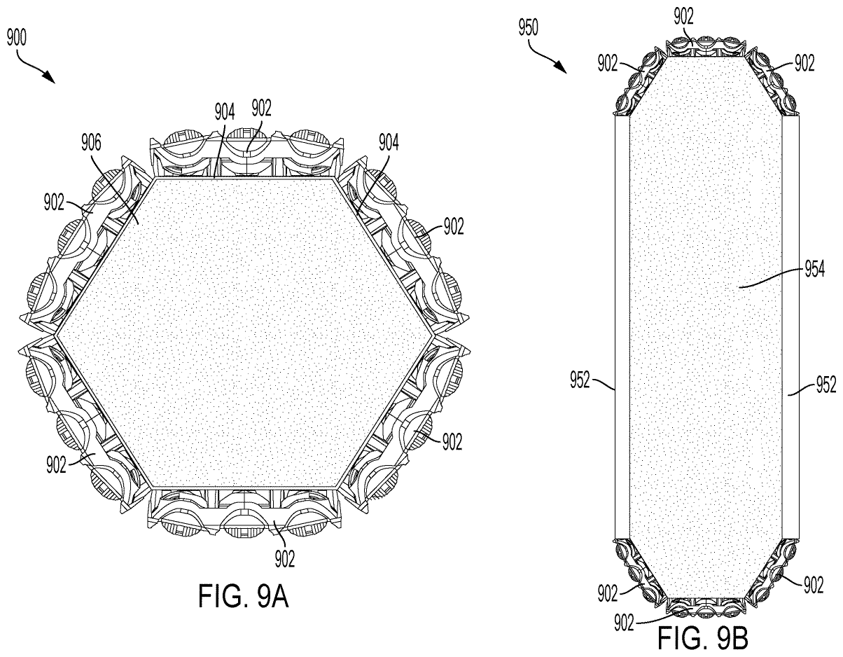

As an example of a multi-faceted fixture that the optical assemblies could be provided on, FIG. 9A shows a top view of a hexagonal fixture 900 (e.g., “fixture 900”) with one or more optical assemblies 902 (or, e.g., “optical modules 902”) disposed around a perimeter of the hexagonal fixture 900. Each optical module 902 may be associated with an illumination PCB 904, and each illumination PCB 904 may be mounted on a support structure 906 (e.g., “base 906”) that provides the general structure of the hexagonal fixture 900. In the embodiment illustrated in FIG. 9A, there are six optical modules 902, however, it should be appreciated that there may be any reasonable number of optical modules 902 disposed around the perimeter of the fixture 900. Solely as an example, there may be two optical modules 902 per face of the hexagonal base 906 of the fixture 900, for a total of twelve optical modules 902 in the fixture 900.

In another embodiment, multiple optical modules 902 are integrated into a circular or oval-shaped fixture, or another shape of fixture with curved sides. The modules 902 may be mechanically mounted along a curved or elliptical support structure 906 that preserves optic-to-optic alignment and maintains a consistent angular pitch around the perimeter. To accommodate curvature, individual PCBs 904 may be connected via flexible interconnects or mounted on segmented carriers that approximate the oval contour. Optical modules 902 on the edges may be angled to provide wraparound visibility, while optic orientations within each module 902 may be rotated or indexed to harmonize beam overlap and uniformity around the curved shape of the support structure 906.

Furthermore, the fixture 900 that the optical modules 902 are mounted on may be functionally zoned by direction. For example, forward-facing optical modules may provide bright forward illumination to shine direct light on the scene of a situation, such as a crash, an accident, a traffic stop, etc. Lateral-facing or rear-facing optical modules may provide emergency lighting, such as red and blue flashing or alternating emergency lights. Rear-facing modules may further implement hazard signaling or scene backlighting. Modules may further be synchronized together to generate coherent rotating, sweeping, waving, or alternating patterns that traverse the perimeter of the support structure 906 of the fixture 900, such as in a clockwise or counterclockwise fashion without mechanical motion. The system may support synchronization signals (e.g., wired or wireless) to coordinate patterns across the various optical modules in the fixture. Moreover, modules on one lightbar may be synchronized with modules on other lightbars. This synchronization can be done through the lightbars synchronizing to a common time source, such as a GPS signal. Further the modules on one or more lightbars can be synchronized through a common controller in wireless communication with each lightbar, or through controllers connected to each lightbar that communicate with each other. Such wireless communication can be achieved by including a communication interface associated with each lightbar and may include, for example, wide area network (WAN) interfaces, local area network (LAN) interfaces, cellular communications, WiFi, or radio frequency communications. In operation, various embodiments may include one or more control units (e.g., a microcontroller, a programmable logic controller (PLC), etc.). The one or more control units may be operatively coupled to one or more input devices, such as a control interface (e.g., analog interfaces, digital interfaces, etc.) that may be used to send one or more command signals to the one or more control units that may be relayed to the lightbars. Inputs may also be provided by one or more sensors and/or may be based, at least in part, on operational configuration of associated components. In the non-limiting example of a vehicle, associated components may include other lights on the vehicle or a state of the vehicle (e.g., parked and idling, operating above a target speed, etc.). One or more signals may be transmitted to the one or more control units to adjust operation of portions of the lightbar responsive to a variety of inputs.

In various embodiments, the one or more control units may be part of, or communicatively coupled to, one or more computing devices (e.g., device), which may include a processor for executing instructions that can be stored in a memory. The device can include many types of memory, data storage, or non-transitory computer-readable storage media, such as a first data storage for program instructions for execution by the processor, a separate storage for images or data, a removable memory for sharing information with other devices, etc. The device may optionally include a display element, such as a touch screen or liquid crystal display (LCD), although devices such as portable media players might convey information via other means, such as through audio speakers, and other devices may not include displays, such as server components executing within data centers, among other options. As discussed, the device in many embodiments will include at least one interaction component able to receive input from a user. This input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device can include one or more network interface or communication components for communicating over various networks, such as a Wi-Fi, Bluetooth, RF, wired, or wireless communication systems. The device may be configured to communicate with a network, such as the Internet, and may be able to communicate with other such devices. The device will also include one or more power components, such as power cords, power ports, batteries, wirelessly powered or rechargeable receivers, and the like.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The optical modules 902 within a fixture may provide directional functional zoning based on module orientation and optical selection. In some embodiments, modules oriented forward, downward, or outward may be assigned to scene illumination, employing bright white light, that is broad and uniform. Modules oriented laterally or rearward may be assigned to emergency warning functions using red, blue, or other colors with high-intensity pulse profiles or synchronized flash sequences. Additionally, optical modules 902 may have one or more color-specific optics to support multi-color warning and scene lighting within a single module. Moreover, some modules of a fixture may be dedicated to utility or task functions, such as search beams, with narrow optics and adjustable tilt for targeted illumination.

In embodiments, the optics modules 902 are arranged in other polygonal shapes besides the hexagonal fixture 900. For example, the fixture 900 may be a triangular fixture, rectangular fixture, octagonal fixture, or other multi-faceted polygonal fixtures. Each face of the polygonal fixture may host one or more optics assemblies 902, and each face may be oriented at a predetermined azimuth to collectively provide 360-degree coverage. Corner or transition faces may employ optics with wider beam divergence to fill inter-facet gaps, while adjacent faces may be overlapped to provide uniform circumferential coverage.

The polygonal fixture may further be implemented as a single tier or as multiple stacked tiers to produce an expanded vertical lighting fixture, where lower tiers provide ground-directed scene lighting and upper tiers provide elevated warning visibility. Upper or lower optics within the modules may also implement vertical stratification where an upper tier or row prioritizes warning lights and a lower tier or row prioritizes scene illumination.

Furthermore, optical modules 902 can be packaged in low-profile housings suitable for roof mounting, grille integration, or peripheral vehicle placement, and may include quick-release mounts (e.g., with snapping legs) to allow rapid replacement or reconfiguration, and to allow for maintenance and replacement of one or more modules 902.

FIG. 9B is a top view of a lightbar 950 with one or more optical assemblies 902 (e.g., “optical modules 902”) disposed at each end of the lightbar 950. In the example embodiment depicted in FIG. 9B, there are three optical modules 902 disposed at each of two ends of the lightbar 950. As with the fixture 900 of FIG. 9A, the lightbar 950 has a support structure 954 that provides the general structure of the lightbar 950. Further shown in FIG. 9B are other light elements 952. The other light elements 952 may be positioned on certain sides of the lightbar 950, such as in FIG. 9A, where the other light elements 952 are positioned on the long sides of the lightbar 950, while the optical modules 902 are disposed the ends of the lightbar 950. In another embodiment, the other light elements 952 may be interspersed with the optical modules 902 around the perimeter of the lightbar 950.

As with embodiments of the fixtures 900 described herein, the optical modules 902 may have different colors, patterns, functions, orientations, etc. within the lightbar 950. For example, in an embodiment, the other light elements 952 provide forward, bright scene lighting for an emergency situation or traffic stop, while the optical modules 902 on the ends of the lightbar 950 provide red and blue flashing, alternating, or pulsing emergency warning lights.

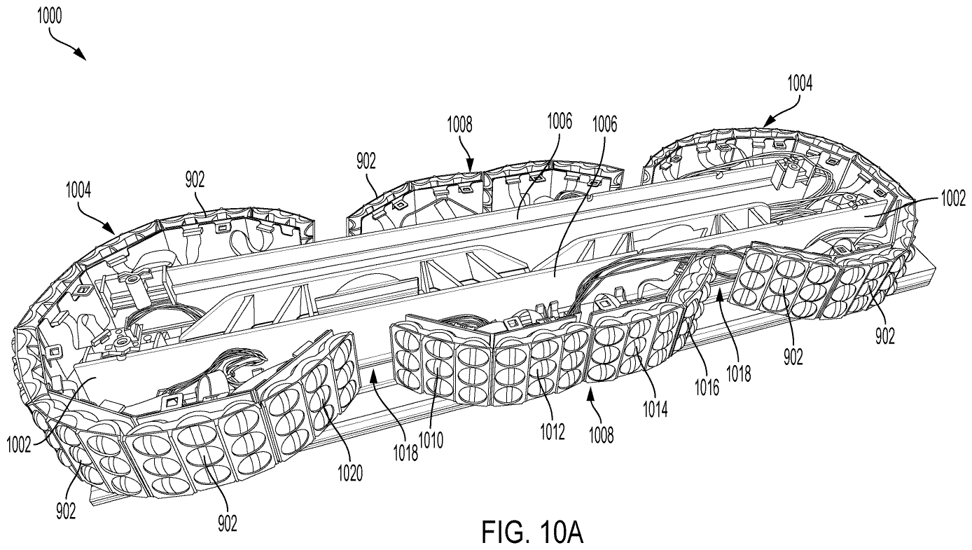

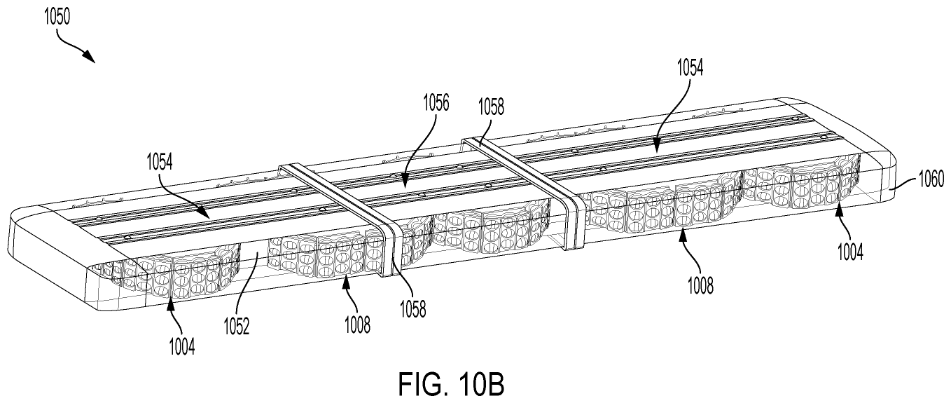

FIG. 10A is a perspective view of a lightbar 1000 with a plurality of optical modules 902 disposed throughout. The lightbar 1000 may include various groupings of optical modules 902, which may provide for complete 360-degree light coverage from the lightbar. Moreover, by selective activation of the optical system in each column of the optical modules, illumination may be provided in selected angular ranges within the 360-degree range. Moreover, different illumination, such as different intensity, color, or illumination patterns, may be provided for the entire 360-degree light coverage or within selected regions of the 360-degree light coverage. At each end 1002 of the lightbar 1000, various optical modules 902 may be arranged in a major arc arrangement 1004, characterized by the optical modules 902 being disposed in almost a full circle (e.g., a circumferential range that is less than 360 degrees). As can be seen in FIG. 10A, the optical modules 902 in the major arc arrangement 1004 may wrap in a continuous arc substantially around the end 1002 of the lightbar 1000. As shown in FIG. 10A, there is a major arc arrangement 1004 of optical modules 902 at each end of the lightbar 1000, but it should be appreciated that the major arc arrangement 1004 may exist only at one end of the lightbar 1000, depending on the embodiment. There may be any number of optical modules 902 arranged in the major arc arrangement 1004, such as, but not limited to, three optical modules 902, four optical modules 902, five optical modules 902, six optical modules 902, seven optical modules 902, eight optical modules 902, nine optical modules 902, or ten optical modules 902. Additionally, each optical module 902 may be positioned at a constant angle relative to each other, or at varying angles. One or more embodiments may include a number of different arcs arranged at different angles forming the major arc arrangement 1004. As a result, the major arc arrangement 1004 may include arcuate structures, polygonal structures, ellipsoid structures, and/or the like.

Other optical modules 902 may be disposed on each of two sides 1006 of the lightbar 1000 in a minor arc arrangement 1008 of optical modules 902. The sides 1006 may form the backbone of the lightbar 1000 and serve as the central or internal support structure for the lightbar 1000. As depicted in FIG. 10A, four optical modules 902 form each minor arc arrangement 1008 on each of two sides 1006 of the lightbar 1000. It should be appreciated that there may be any reasonable number of optical modules 902 included in each minor arc arrangement 1008 on the sides 1006 of the lightbar 1000, such as two, three, five, six, seven, eight, nine, or ten optical modules 902. For example, when three optical modules 902 are included in a minor arc arrangement 1008, there may be a first, middle optical module aligned substantially parallel to the sides of the lightbar, with second and third optical modules positioned on either side of the first module and aligned at angles with respect to the sides of the lightbar. Additionally, each optical module 902 may be positioned at a constant angle relative to each other, or at varying angles. That is, certain optical modules 902 can be positioned at different relative angles with respect to different other optical modules 902 in the lightbar.

In each minor arc arrangement 1008 of FIG. 10A, there may be a first optical module 1010, a second optical module 1012, a third optical module 1014, and a fourth optical module 1016. In the embodiment illustrated in FIG. 10A, the second optical module 1012 and the third optical module 1014 may be aligned parallel to the sides 1006 of the lightbar 1000 such that light from at least some lighting elements in the second optical module 1012 and the third optical module 1014, or at least a portion thereof, may be directed substantially at a 90-degree angle from the lightbar 1000. It should be appreciated that various embodiments may include optical modules that include columns and/or rows that are arranged at different angles, and therefore, mounting one or more optical modules flush against a flat plate may cause at least some of the lighting elements to be arranged at an angle. In the embodiment of FIG. 10A, the first optical module 1010 is at a defined angle with respect to the second optical module 1012, and the fourth optical module 1016 is at the same angle with respect to the third optical module 1014.

Furthermore, on the lightbar 1000, there may be gaps 1018 in the arrangements of optical modules 902 between the various major and minor arcs 1004, 1008. In various embodiments, across a gap 1018 between a major arc 1004 and a minor arc 1008, at least one optical module of the minor arc arrangement 1008 and at least one optical module of the major arc arrangement 1004 may be angled partially toward each other. In the embodiment illustrated in FIG. 10A, an optical module 1020 of the major arc arrangement 1004 may be angled partially toward the minor arc arrangement 1008, and the first optical module 1010 of the minor arc arrangement 1008 may be angled partially toward the major arc arrangement 1004. In other words, the optical modules of the major arc arrangement 1004 may curve around the end 1002 of the lightbar 1000, with the optical modules at the distal ends of the major arc 1004 bending back into the sides 1006 of the lightbar 1000. As such, light emitted from the optical module 1020 of the major arc arrangement 1004 and the first optical module 1010 of the minor arc arrangement 1008 may intersect.

The optical modules of the major and minor arcs 1004, 1008 within the lightbar may provide directional functional zoning based on module orientation and optical selection. In some embodiments, optical modules of the major arcs 1004 may be assigned to scene illumination, and optical modules of the minor arcs 1008 may be assigned to emergency warning functions, or vice versa. Further, optical modules of the major and minor arcs 1004, 1008 may emit white, amber, red, blue, or other colors with high-intensity pulse profiles or synchronized flash sequences. Moreover, the optical modules of the major arcs 1004, or the optical modules of the minor arcs 1008, or both, may be dedicated to utility or task functions, such as search beams, with narrow optics and adjustable tilt for targeted illumination.

FIG. 10B is a perspective view of a lightbar 1050 with a protective lens 1052. The lightbar 1050 and protective lens 1052 may have one or more sections, such as long sections 1054 and short sections 1056. As discussed herein, the long sections 1054 may have a larger longitudinal extent than the short sections 1056. In the embodiment illustrated in FIG. 10B, there are two long sections 1054 and one short section 1056 positioned between the two long sections 1054. At each end of the long sections 1054 of the lightbar 1050, there is a major arc arrangement 1004 of optical modules. In the middle of the lightbar 1050, within the short section 1056, there may be an additional major arc arrangement 1004, or a minor arc arrangement 1008. Between various long and short sections 1054, 1056 of the protective lens 1052 of the lightbar 1050, there may be connectors 1058. The connectors 1058 may include fasteners to secure sections of the protective lens 1052 together, and the connectors 1058 may also include gaskets or seals 1058, which may protect the inside of the lightbar 1050 from moisture, debris, etc.

The protective lens 1052 may include transparent edges 1060 positioned in front of the optical modules. The transparent edges 1060 may allow light from the optical modules to pass through, while protecting the modules from debris, impact, or other damage and wear. In various embodiments, the transparent edges 1060 extend substantially around the entire lightbar 1050.

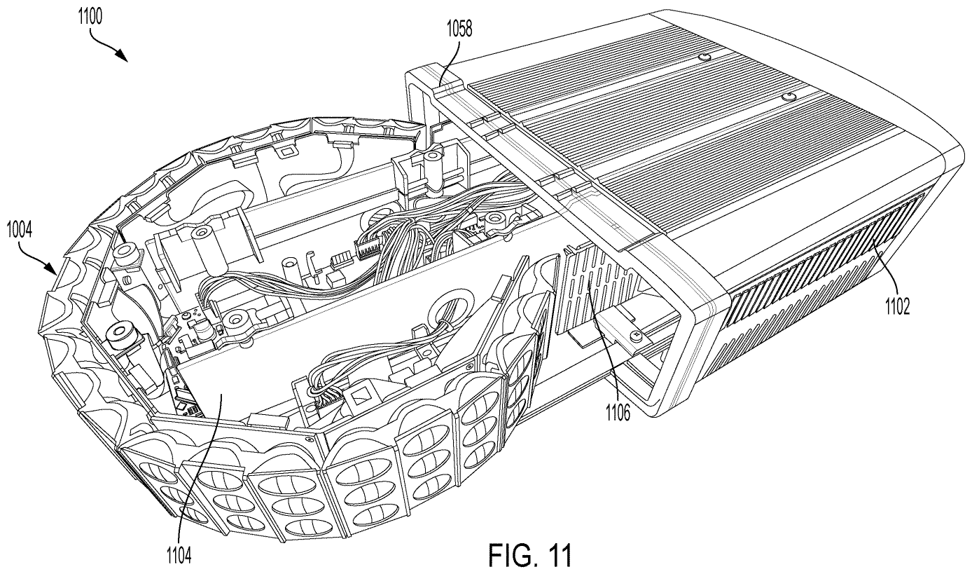

FIG. 11 is a perspective view of a shortened lightbar 1100 partially enclosed by a protective lens 1102. The lightbar 1100 of FIG. 11 has two major arc arrangements 1004 of optical modules included on a backbone or support structure 1104 of the lightbar 1100. Similar to the embodiment illustrated in this FIG. 11, there may not be any minor arc arrangements 1008 included on the lightbar 1100. Similar to FIG. 10B, the protective lens 1102 may include a connector or gasket 1058. Moreover, positioned between the two major arc arrangements 1004 of optical modules may be an ornamental piece 1106. The ornamental piece 1106 may be patterned, opaque, reflective, or transparent, depending on the embodiment. In the embodiment illustrated in FIG. 11, each of the two major arc arrangements 1004 includes eight optical modules; however, the major arc arrangements 1004 of the lightbar 1100 may include different amounts of optical modules, depending on the embodiment.

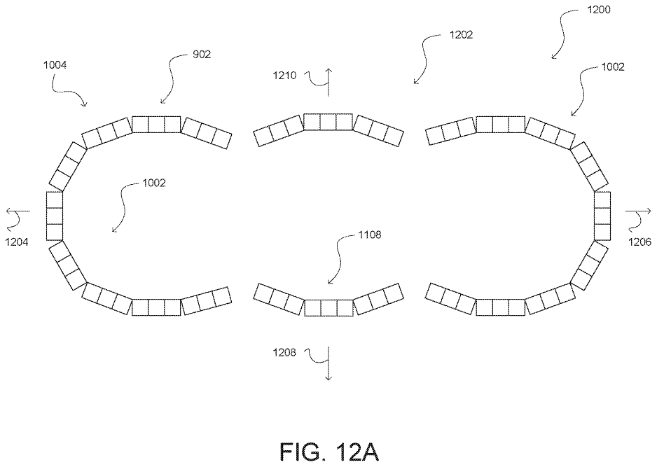

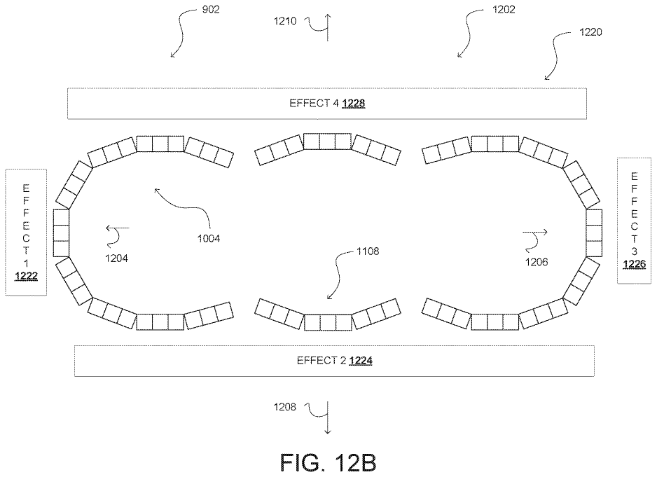

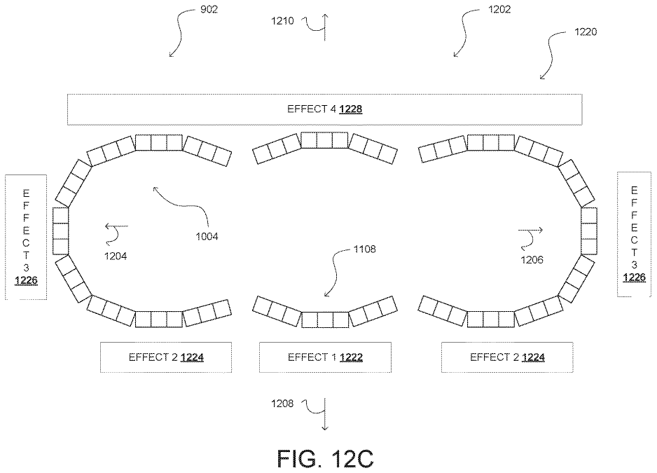

FIG. 12A illustrates an example schematic representation of a lighting configuration 1200 for a lightbar 1202, that may be used with embodiments of the present disclosure. FIG. 12A illustrates sets of major arc arrangement 1004 at different ends 1002 of lightbar 1202 and minor arc arrangements 1108 between the major arc arrangements 1004. The lightbar 1202 may have substantially 360 degree coverage with the arrangement of the individual optical modules 902, which as discussed here, may be positioned at different angles relative to one another to provide an arcuate, polygonal, or other structure.

One or more embodiments may be described with respect to different directions of from the lightbar 1202, which may include a first direction 1204 (e.g., a forward direction), a second direction 1206 (e.g., a backward direction), a third direction 1208 (e.g., a left sided direction), and a fourth direction 1210 (e.g., a right side direction). As one example, the lighting configuration 1200 may provide a top down view of the lightbar 1202 mounting on a vehicle (not pictured). Systems and methods of the present disclosure may be used to generate different lighting configurations by selectively illuminating one or more of the optical modules 902. Selective illumination may include adjusting/setting a color, adjusting/setting a brightness or intensity, adjusting/setting patterns, and/or the like. For example, selective illumination may include selecting at least a subset of the optical modules 902 to illuminate, at least in part, with a first color, and then selecting a subset of the optical modules 902 to illuminate, at least in part, with a second, different color. Furthermore, timing may be applied so that different optical modules 902 are illuminated at particular times, with particular colors/intensities, to provide a variety of different effects. One or more embodiments may further selectively target different lighting effects for different portions of optical modules 902. For example, a first effect may be applied in the first direction 1204, a second effect may be applied in the second direction 1206, a third effect may be applied in the third direction 1208, and a fourth effect may be applied in the fourth direction 1210.

FIG. 12B illustrates an example configuration 1220 that may be used with embodiments of the present disclosure. In at least one embodiment, the example configuration 1220 includes a plurality of different lighting effects for each of the first direction 1204, second direction 1206, third direction 1208, and fourth direction 1210. By way of non-limiting example, the first direction 1204 may be a forward facing direction for a vehicle that includes the lightbar 1202 and a first effect 1222 (e.g., Effect 1) may include a spotlight effect, which may be used to illuminate a scene in bright white light. The second direction 1206 may be a reward facing direction for the vehicle and a second effect 1224 (e.g., Effect 2) may include a road hazard effect to alert upcoming motorists of the presence of the vehicle. The third direction 1208 may be a left side facing direction for the vehicle, such as a side closest to a roadway, and may include a third effect 1226 (e.g., Effect 3) that may include a traffic advisor pattern. The fourth direction 1210 may be a right side facing direction for the vehicle, such as a side closest to a shoulder of the roadway, and may include a fourth lighting effect 1228 (e.g., Effect 4) that may include scene lighting.

One or more embodiments may also, or alternatively, enable alternating patterns that extend across subsets of the optics used at each portion of the lightbar 1202. For example, a strobe or flashing effect may be provided by illuminating subsets of different lights, which may include timed illumination to provide the illusion of a sweeping light. Furthermore, embodiments may be used to establish hierarchies for different lighting effects, such as a strobe or flashing pattern moving between different modules would not override an existing illumination effect with a higher rank. FIG. 12C illustrates an example lighting configuration 1240 in which a portion of the third side 1208 has two different lighting effects 1222, 1224, operating along the same side. As discussed herein, different patterns for effects may be established such that different sets of optical elements are illuminated with different effects are different periods of time. For example, at a first time (e.g., t1) the third side 1208 may be illuminated as shown in FIG. 12C, but at a second time (e.g., t2) the third side 1208 may be illuminated in an alternative configuration, such as including two sets with the first lighting effect 1222 and only one set with the second lighting effect 1224. In this manner, systems and methods of the present disclosure may individually target and control lighting effects at different portions of the lightbar 1202, such as on a per row, per optic, per arc arrangement, and/or combinations thereof. Moreover, the lighting modules of multiple lightbars may be controlled to coordinate or synchronize light output.

The control unit providing signals to the optical modules may receive information from sensors including cameras, radar sensors, LIDAR sensors, global positioning units, speed sensors, and accelerometers. The control unit may process information from sensors to control the optical modules. For example, signals from a camera sensor or radar sensor may be processed to detect a person, vehicle, or object of interest in the vicinity of the lightbar. The control unit may use information regarding the position and relative position of such people, vehicles, and objects to the lightbar to control the lights. This includes providing selected illumination that tracks the object, sweeping or steering the light output by selectively controlling the various lighting units with the lighting modules. For example, the lighting modules can be controlled to maintain white light on a person or vehicle of interest in the vicinity of the lightbar, to direct flashing warning lights in the direction of hazards around the lightbar, and/or to direct light of different intensity or color at different objects. Moreover, the lighting modules can be controlled to direct light of particular colors, intensity, or flash patterns in selected areas of the overall light output from the lightbar in response to information from the sensors.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. An optical system, comprising:
one or more light sources configured to produce emitted light;
a lens;
a cradle supporting the lens; and
a wide-angle emission collecting optic positioned, at least in part, within the cradle, the wide-angle emission collecting optic comprising a substantially concave shape;
wherein a first portion of the emitted light is reflected off of the wide-angle emission collecting optic to produce reflected light, and wherein the reflected light passes through the lens.

2. The optical system of claim 1, wherein a light source of the one or more light sources is substantially centered on a lens focal point of the lens.

3. The optical system of claim 2, wherein a second portion of emitted light is emitted from the light source at the lens focal point of the lens, and wherein the second portion of emitted light is collimated by the lens.

4. The optical system of claim 3, wherein a third portion of emitted light is emitted from the light source at a point other than the lens focal point of the lens, and wherein the third portion of emitted light is not collimated by the lens.

5. The optical system of claim 4, wherein the third portion of emitted light passes through the lens to define a beam width angle of the optical system.

6. The optical system of claim 1, wherein the wide-angle emission collecting optic has a focal point substantially coincident with a lens focal point of the lens.

7. The optical system of claim 1, wherein the one or more light sources comprises:
a first light source, where the first light source emits light of a first color;
a second light source, where the second light source emits light of a second color; and
a third light source, where the third light source emits light of a third color.

8. The optical system of claim 1, wherein the wide-angle emission collecting optic is positioned on a first side of the one or more light sources and a second wide-angle emission collecting optic is positioned on a second side of the one of more light sources.

9. The optical system of claim 1, wherein the wide-angle emission collecting optic extends substantially around the one or more light sources.

10. The optical system of claim 1, wherein the lens comprises an acceptance angle that is less than an emission pattern of a light source of the one or more light sources.

11. An optical assembly, comprising:
two or more optical systems, each optical system comprising:
one or more light sources configured to produce emitted light;
a lens; and
a wide-angle emission collecting optic positioned within the optical system;
wherein a first portion of the emitted light is reflected off of the wide-angle emission collecting optic to produce reflected light, and wherein the reflected light passes through the lens; and
a plate or printed circuit board;
one or more snapping arms, wherein the one or more snapping arms secure the plate to the two or more optical systems;
wherein the two or more optical systems are arranged in one or more columns and one or more rows on the plate.

12. The optical system of claim 11, wherein the two or more optical systems arranged in a first column of the one or more columns are oriented in a first direction.

13. The optical system of claim 12, wherein the two or more optical systems arranged in a second column of the one or more columns are oriented in the first direction.

14. The optical system of claim 12, wherein the two or more optical systems arranged in a second column of the one or more columns are oriented in a second direction different than the first direction.

15. The optical system of claim 11, wherein the two or more optical systems comprises nine optical systems arranged in three columns and three rows.

16. The optical system of claim 11, wherein the wide-angle emission collecting optic comprises a substantially concave shape.

17. The optical system of claim 11, wherein the one or more light sources comprises:
a first light source, where the first light source emits light of a first color;
a second light source, where the second light source emits light of a second color; and
a third light source, where the third light source emits light of a third color.

18. The optical system of claim 11, wherein the wide-angle emission collecting optic is positioned on a first side of the one or more light sources and a second wide-angle emission collecting optic is positioned on a second side of the one of more light sources.

19. The optical system of claim 11, wherein the wide-angle emission collecting optic extends substantially around the one or more light sources.

20. An optical lens, comprising:
a center line;
a focal point; and
a refracting lens section about the center line, comprising:
a refracting entrance surface; and
a refracting exit surface.

21. The optical lens of claim 20, further comprising:
a Total Internal Reflection (TIR) lens section, comprising:
a TIR entrance surface;
a TIR surface; and
a TIR exit surface.

22. The optical lens of claim 21, wherein the TIR lens section substantially surrounds the refracting lens section about the center line.

23. The optical lens of claim 22, wherein the TIR exit surface of the TIR lens section comprises a TIR exit surface plane, the TIR exit surface plane being substantially perpendicular to the center line.

24. The optical lens of claim 20, wherein the refracting exit surface of the refracting lens section comprises a substantially domed shape.
